(19) United States
(12) Patent Application Publication
(10) Pub. No.: US 2013/0207420 A1
(43) Pub. Date: Aug. 15, 2013

(54) CLIMATE CONTROL SYSTEM FOR A VEHICLE

(71) Applicants: Mukesh Kumar, Canton, MI (US); Martha Elizabeth Nefcy, Dearborn, MI (US); Lawrence C. Karas, New Boston, MI (US); Paul Bryan Hoke, Plymouth, MI (US); Harry Christian Martinez, Northville, MI (US); Spencer Dinkins, Pontiac, MI (US); Frank Fusco, Plymouth, MI (US); Eric R. Yerke, Redford, MI (US)

(72) Inventors: Mukesh Kumar, Canton, MI (US); Martha Elizabeth Nefcy, Dearborn, MI (US); Lawrence C. Karas, New Boston, MI (US); Paul Bryan Hoke, Plymouth, MI (US); Harry Christian Martinez, Northville, MI (US); Spencer Dinkins, Pontiac, MI (US); Frank Fusco, Plymouth, MI (US); Eric R. Yerke, Redford, MI (US)

(73) Assignee: FORD GLOBAL TECHNOLOGIES, LLC, Dearborn, MI (US)

(21) Appl. No.: 13/396,941

(22) Filed: Feb. 15, 2012

(51) Int. Cl. B60J 7/043

(52) U.S. Cl. 296/217

(57) ABSTRACT

A climate control system for a vehicle includes an air conditioner positioned in a rear of the vehicle. A roof panel includes a moonroof opening bounded on at least one side by a moonroof rail. The moonroof rail generally defines an air supply duct between a headliner and the roof panel. The air supply duct is in communication with the air conditioner. A plurality of vents are operably connected to the moonroof rail and relay conditioned air from the air supply duct to an interior of the vehicle.

### FIELD OF THE INVENTION

The present invention generally relates to overhead climate control systems, and more particularly to a climate control system having an air supply duct defined by structural frame members.

### BACKGROUND OF THE INVENTION

In current automotive vehicles, an increased number of components required for occupant safety and comfort are being included in the roof portion of a vehicle. At the same time, many vehicles are being manufactured and sold with sliding roofs, multiple moonroofs, and so-called “panoramic roofs,” in which a large glass sheet is used for the roof in place of the traditional sheet metal roof.

### SUMMARY OF THE INVENTION

According to one aspect of the present invention, a climate control system for a vehicle includes an air conditioner positioned in a rear of the vehicle. A roof panel includes a moonroof opening bounded on at least one side by a moonroof rail. The moonroof rail generally defines an air supply duct between a headliner and the roof panel. The air supply duct is in communication with the air conditioner. A plurality of vents are operably connected to the moonroof rail and relay conditioned air from the air supply duct to an interior of the vehicle.

According to another aspect of the present invention, a climate control system for a vehicle includes a roof support structure having a peripheral tubular member. The peripheral tubular member generally defines an air supply duct disposed between a headliner and a roof panel and is in communication with an air conditioner. A plurality of vents extend from the air supply duct that relay conditioned air to an interior of the vehicle.

According to another aspect of the present invention, a climate control system for a vehicle includes a roof panel having a headliner coupled thereto. A plurality of structural frame members are disposed between the headliner and the roof panel. An air supply duct is defined by the structural frame members and is in communication with an air conditioner. A plurality of vents relay conditioned air from the air supply duct to an interior of the vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a side perspective view of a vehicle equipped with a climate control system according to one embodiment of the present invention;

FIG. 2 is a side perspective view of the vehicle of FIG. 1, including two moonroofs;

FIG. 3 is a side perspective exploded view of the climate control system of FIG. 1;

FIG. 4 is a cross-sectional view of a portion of the vehicle, including the climate control system, taken along line IV-IV of FIG. 1;

FIG. 5 is a cross-sectional view of a portion of the vehicle, including the climate control system, taken along line V-V of FIG. 1;

FIG. 6 is a side perspective view of a vehicle equipped with a climate control system according to another embodiment the present invention;

FIG. 7 is a side perspective exploded view of the climate control system of FIG. 6;

FIG. 8 is a top side perspective view of the climate control system of FIG. 6;

FIG. 9 is a top plan view of the climate control system of FIG. 6; and

FIG. 10 is a side elevational view of the climate control system of FIG. 6.

### DETAILED DESCRIPTION OF THE PREFERRED EMBODIMENTS

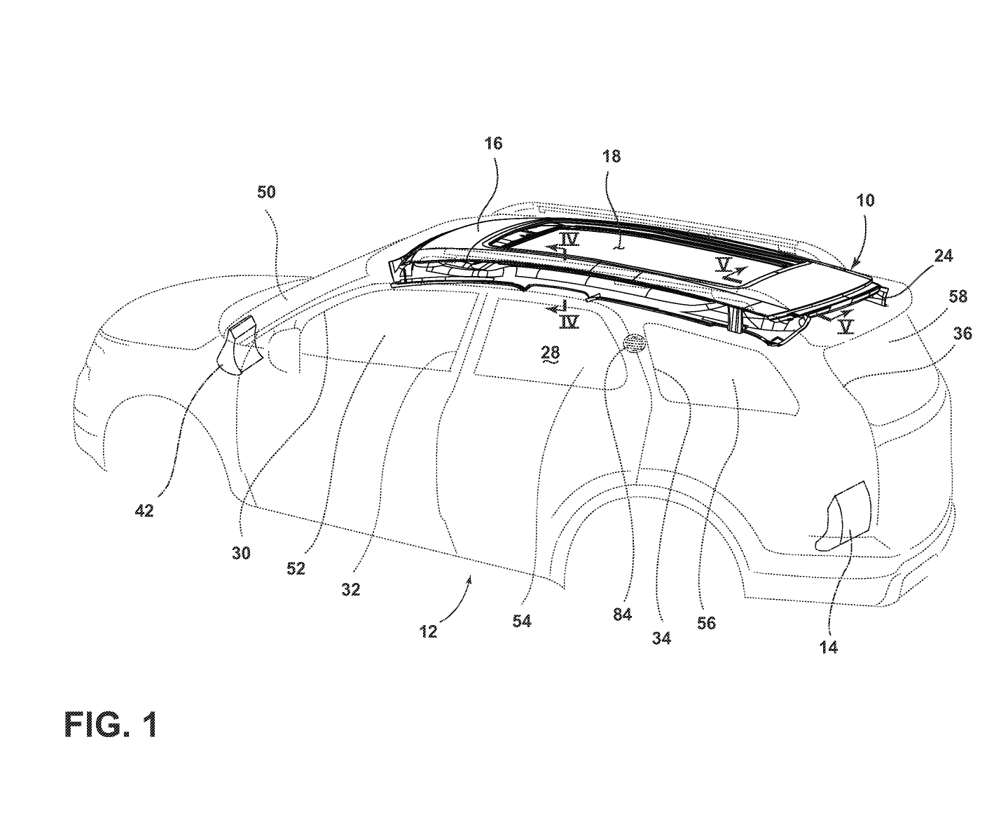

For purposes of description herein, the terms “upper,” “lower,” “right,” “left,” “rear,” “front,” “vertical,” “horizontal,” “interior,” “exterior,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1-3, reference numeral 10 generally designates one embodiment of a climate control system for a vehicle 12. The climate control system 10 comprises an air conditioner, illustrated as rear air conditioning unit 14, positioned in a rear of the vehicle 12, a roof panel 16 having a moonroof opening 18 bounded on at least one side by a moonroof rail 20. The moonroof rail 20 generally defines an air supply duct 22 disposed between a headliner 24 and the roof panel 16. The air supply duct 22 is in fluid communication with the air conditioner 14. The climate control system 10 also includes a plurality of vents 26 that are operably connected to the moonroof rail 20 and that relay conditioned air from the air supply duct 22 to an interior 28 of the vehicle 12.

As illustrated, the vehicle 12 includes a body 27 having a roof 29. The roof 29 of the (non-convertible top) vehicle 12 includes a pair of side rails and a front and rear cross rail, commonly referred to in the automotive industry as a “header,” “front roof bow,” “rear roof bow,” and “side rails.” The roof includes a frame for the upper portion of the vehicle 12, to which interior and exterior components, such as the roof panel 16 and the headliner 24, can be affixed. The roof 29 is connected to the body 27 of the vehicle 12 by a plurality of pillars. The illustrated vehicle 12 of FIG. 1 includes an A-pillar 30 disposed at a forward portion of the interior 28 of the vehicle 12, a B-pillar 32 is disposed between a first row and a second row of vehicle seating, a C-pillar 34 is disposed between the second row of seating and a trunk space, and a D-pillar 36 is disposed at a rearward portion of the vehicle 12.

The vehicle 12 has a roof support structure 38 that generally includes a glass frame 40 and the roof panel 16. The roof panel 16 is formed of sheet metal and is affixed to the glass frame 40, typically joined together by spot welding, or any other suitable means. The vehicle 12 may also include a front air conditioning unit 42 that is located at a forward portion of the vehicle 12, typically forward of an instrument panel. The front air conditioning unit 42 can supplement, or replace, the air flow that is supplied by the rear air conditioning unit 14.

The vehicle 12, as illustrated, also includes a plurality of windows. As shown in the drawings, a windshield 50 is disposed at a forward portion of the interior 28 of the vehicle 12; a front window 52 is disposed rearward of the windshield 50 and between the A and B-pillars 30, 32; a side window 54 is disposed between the B and C-pillars 32, 34; a rear window 56 is disposed between the C and D-pillars 34, 36; and a rear windshield 58 is disposed at a rearward portion of the vehicle 12.

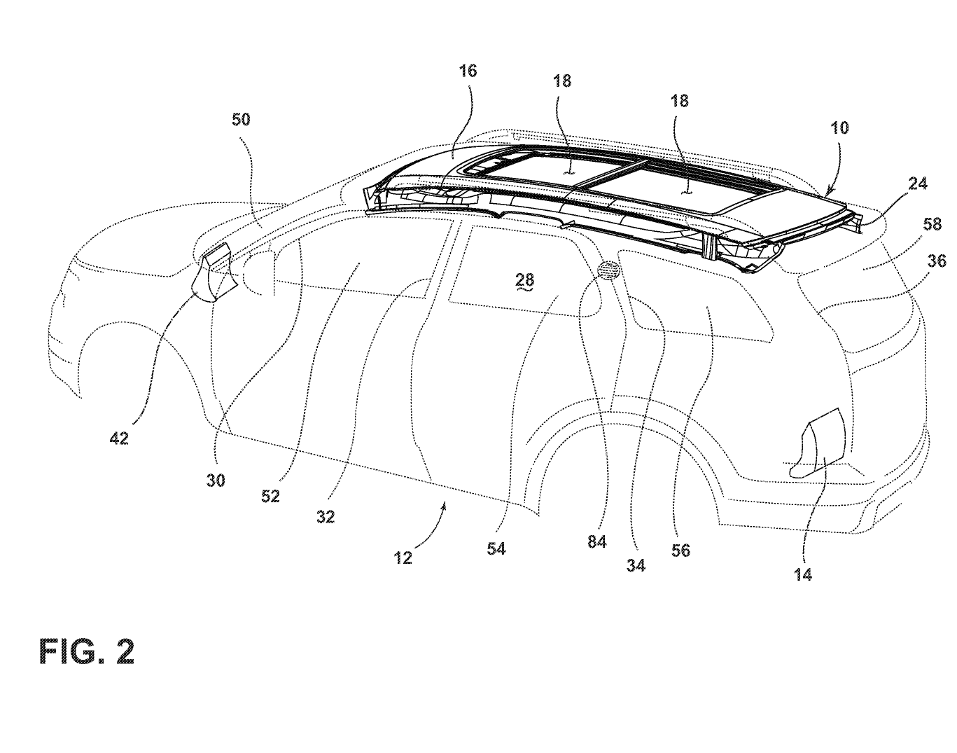

The roof support structure 38 includes a large window, commonly referred to in the automotive industry as a panoramic roof, defined by the moonroof opening 18 and enclosed by a large glass sheet or transparent plastic material. The moonroof opening 18 is bounded on longitudinal sides by the two moonroof rails 20 and on a rear lateral side by a rear moonroof rail 60. The moonroof rails 20, 60 are structural frame members and provide structural support for the moonroof opening 18 and the moonroof glass. Additionally, it should be noted that the vehicle 12 may include more than one moonroof opening 18, such as the exemplary two moonroof openings 18 shown in FIG. 2.

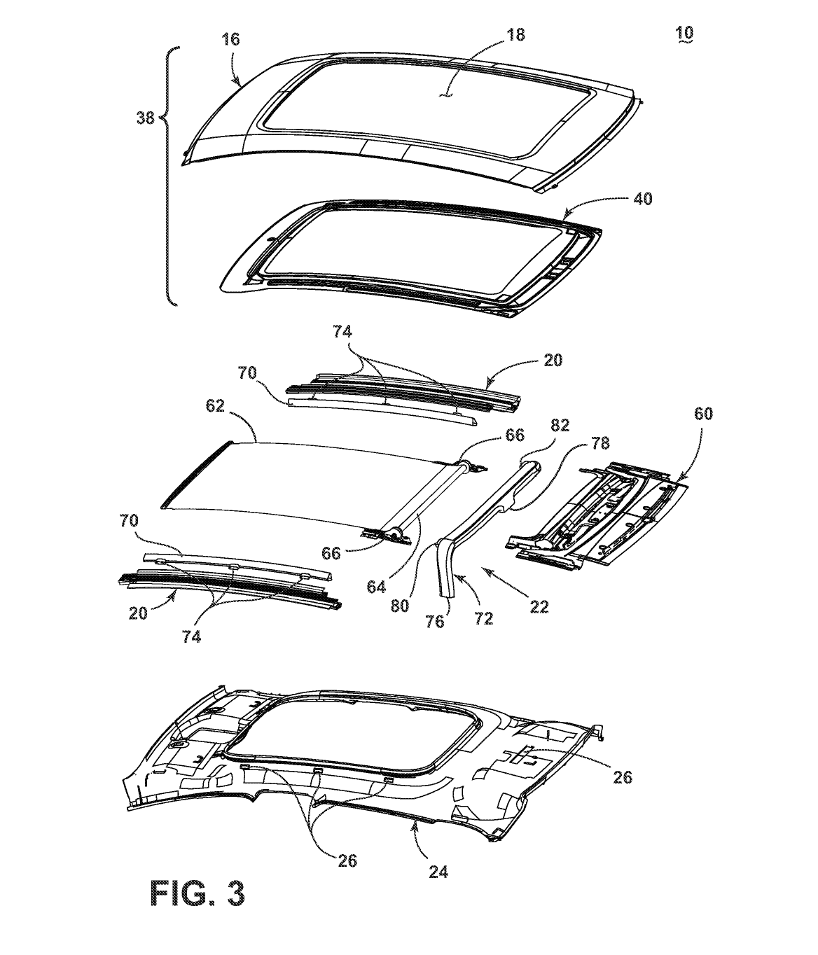

As illustrated in FIG. 3, the vehicle 12 also includes a sun-shade 62 which is wound onto a winding reel 64 disposed between the headliner 24 and the roof panel 16. The winding reel 64 includes a pair of rollers 66 that assist in movement of the sun-shade 62 between deployed and retracted positions. The sun-shade 62 can be pulled forward, either manually or by automatic means, to cover all or a part of the moonroof opening 18.

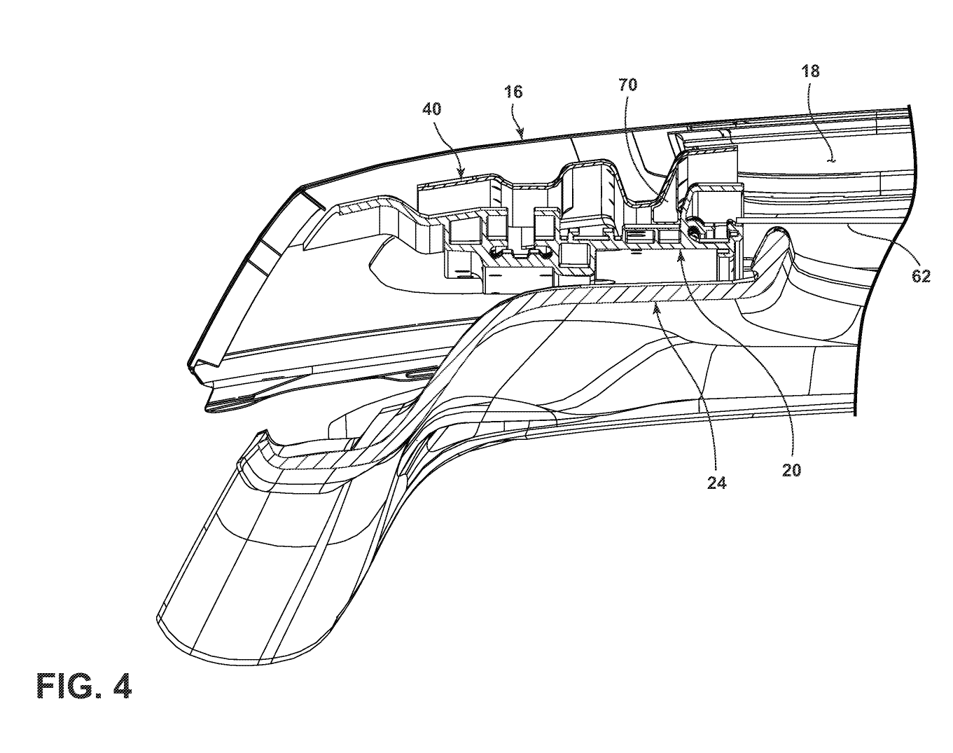

The air supply duct 22 includes a pair of spaced and longitudinally extending side ducts 70 and a laterally extending rear cross-car duct 72 that includes a substantially vertical relay portion 73 and a substantially laterally extending portion 75. As illustrated in FIG. 4, the side duct 70 is disposed between the headliner 24 and the roof panel 16. More specifically, the side duct 70 is disposed in the void between the moonroof rail 20 and the glass frame 40 and extends along a substantial portion or all of the moonroof rail 20. Alternatively, the side duct 70 can be disposed in the void between the headliner 24 and the moonroof rail 20. It should be understood that one side duct 70 extends along a driver-side of the vehicle 12, and the other side duct 70 extends along a passenger-side of the vehicle 12. Further, the side ducts 70 include a plurality of outlets 74 that fluidly connect the side ducts 70 to the corresponding vents 26 positioned in the headliner 24.

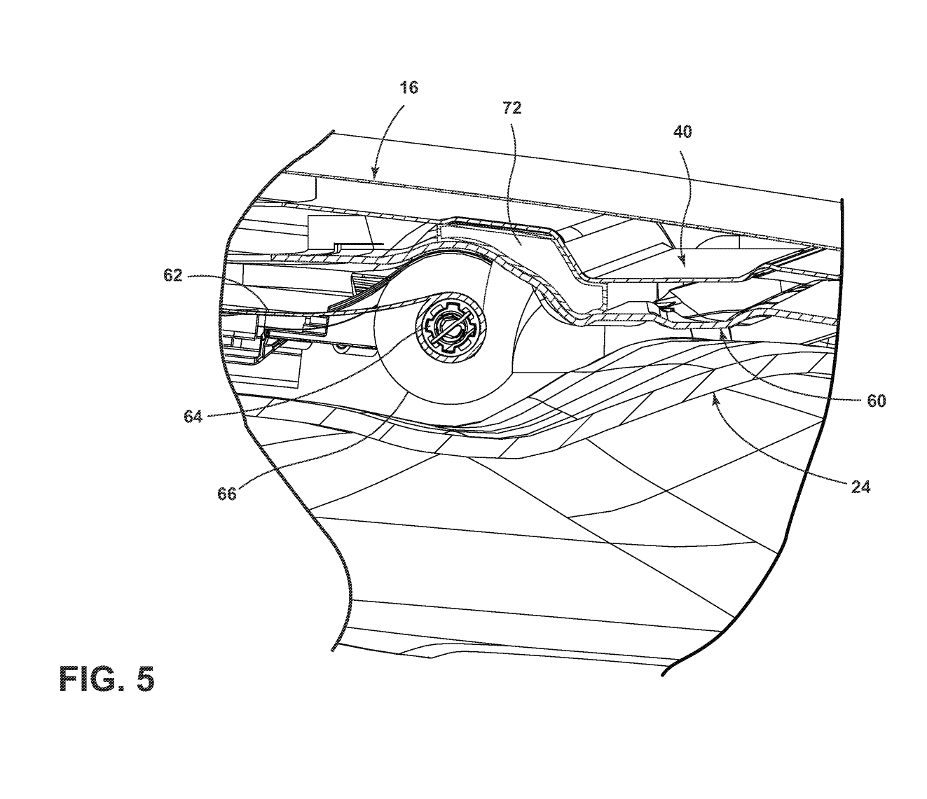

Referring now to FIGS. 3 and 5, the rear cross-car duct 72 is disposed between the headliner 24 and the roof panel 16. More specifically, the rear cross-car duct 72 is disposed in the void between the rear moonroof rail 60 and the glass frame 40. The cross-car duct 72 includes an inlet 76, a center outlet 78, a driver-side outlet 80, and a passenger-side outlet 82. The inlet 76 fluidly connects the cross-car duct 72 to the rear air conditioning unit 14 and the outlets 80, 82 fluidly connect the cross-car duct 72 to each of the side ducts 70. Further, the center outlet 78 fluidly connects the cross-car duct 72 to the corresponding vent 26 positioned in the headliner 24. The ducts 70, 72 may be joined together using any suitable method that provides a substantially air-tight connection.

While it is shown that the air supply duct 22 is a discrete, formed conduit disposed between adjacent components, it should be understood that the air supply duct 22 can alternatively be defined by the void formed between the adjacent components. Specifically, the side duct 70 can be defined by the void between the headliner 24 and the moonroof rail 20, or the side duct 70 can be defined by a discrete, formed, and shaped conduit that is positioned within the space between the headliner 24 and the moonroof rail 20. Similarly, the cross-car duct 72 can be defined by the void between the rear moonroof rail 60 and the glass frame 40, or the cross-car duct 72 can be defined by a discrete, formed, and shaped conduit that is positioned within the space between the rear moonroof rail 60 and the glass frame 40.

As illustrated in the embodiment of FIGS. 1 and 2, a vent 84 is positioned in one of the pillars 30-36, and in fluid communication with the air supply duct 22. The vent 84 is shown in the C-pillar 34, and is fluidly connected to the side duct 70 by a connecting duct. The illustrated example is just one example of possible locations for the vent 84, other locations in the pillars 30, 32, 36 are also feasible.

In operation, conditioned air flows from the rear air conditioning unit 14 and into the inlet 76 of the cross-car duct 72. From the cross-car duct 72, air may flow through any of the three outlets: the center outlet 78, driver-side outlet 80, and passenger-side outlet 82. Air that flows through the driver-side outlet 80 flows into the driver-side side duct 70, through outlets 74, and into the interior 28 of the vehicle 12 via the vents 26. It will be understood that a similar airflow path occurs through the passenger-side of the vehicle 12. Additionally, air may flow directly out of the cross-car duct 72 into the interior 28 of the vehicle 12 through the center outlet 78 and vent 26.

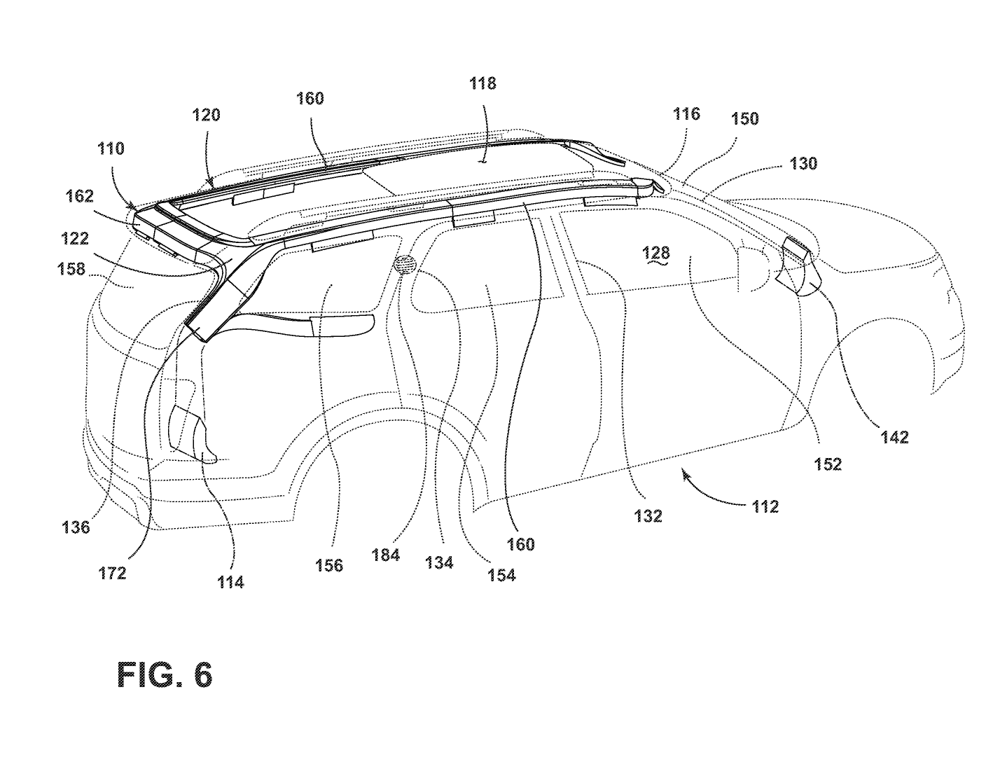

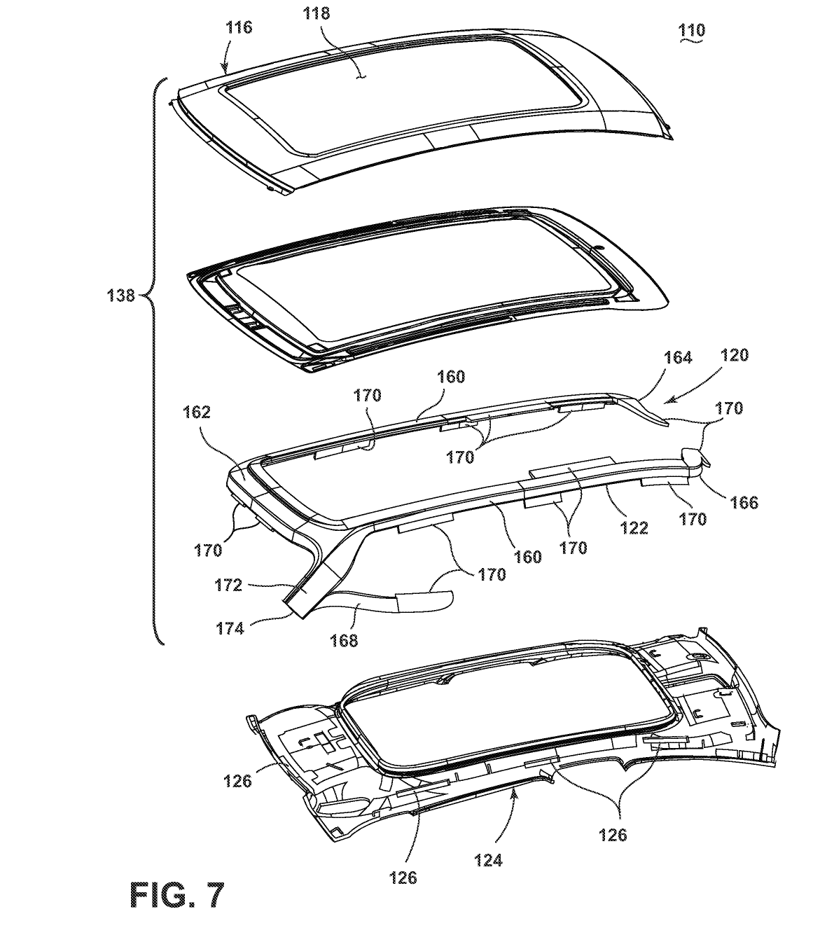

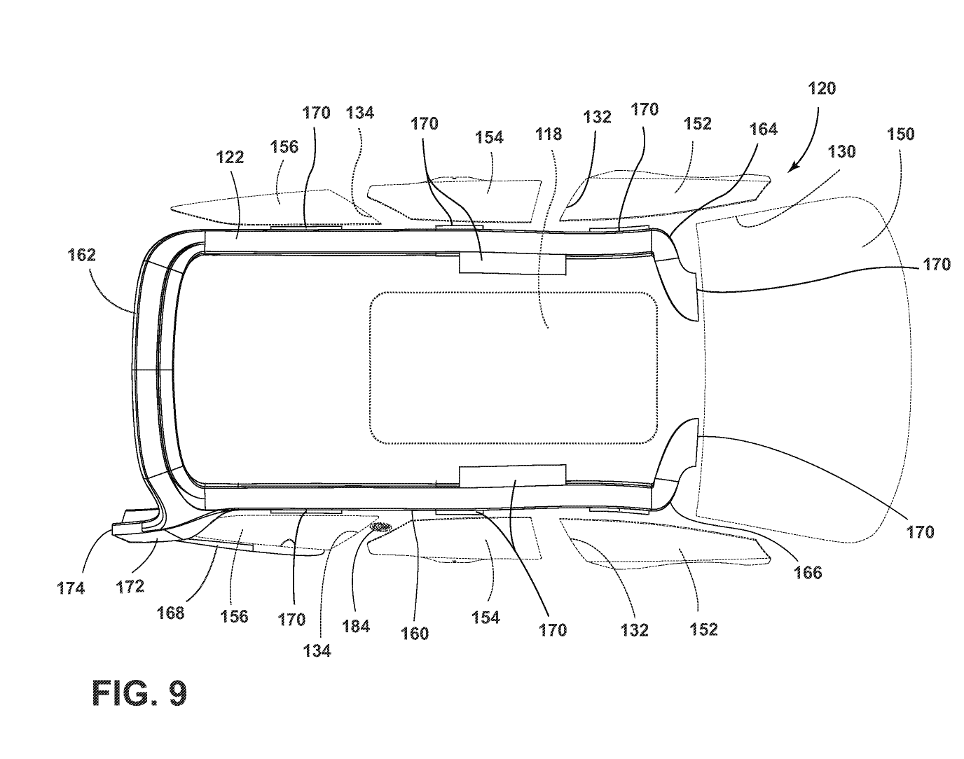

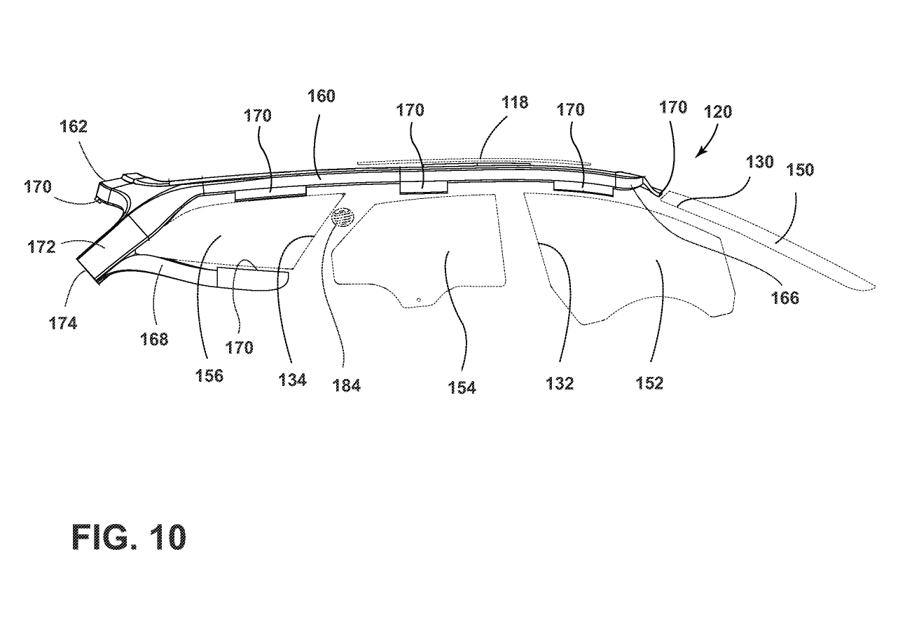

Referring now to FIGS. 6-10, a second embodiment of a climate control system 110 is illustrated, where elements from the first embodiment are labeled with the same reference numerals increased by 100. The climate control system 110 comprises a roof support structure 138 including a peripheral tubular member 120, which generally defines an air supply duct 122. The air supply duct 122 is disposed between a headliner 124 and a roof panel 116, and is in communication with an air conditioner, illustrated as rear air conditioning unit 114. The climate control system 110 further comprises a plurality of vents 126 that are disposed in the headliner 24 and extend from the air supply duct 122 to relay conditioned air to an interior 128 of the vehicle 112. Additionally, a moonroof 118 may be disposed in the roof panel 116, the moonroof 118 being surrounded by the roof support structure 138. It should be noted that the vehicle 112 may include more than one moonroof 118.

In some cases, the roof of the vehicle 112, as described above, can be formed by a manufacturing process called hydroforming. The process of hydroforming involves shaping the metal into a lightweight, structurally stiff and strong component. In general, a hollow tube of malleable metal is placed inside a negative mold that has the shape of the desired end result. High pressure hydraulic pumps inject fluid at very high pressure inside the metal tube, causing it to expand until it matches the mold. The hydroformed component is then removed from the mold, creating a portion of the roof rail.

The peripheral tubular member 120 is a structural frame member made up of several members: two side rails 160 and a rear roof bow 162. As described above, the side rails 160 and rear roof bow 162 are made of a malleable metal manufactured using the hyrdoforming process, or any other suitable manufacturing process that results in an elongated, hollow member. The peripheral tubular member 120 also includes a driver-side front extension 164, a passenger-side front extension 166, and a lower rear extension 168. The extensions 164, 166, 168 can be made of metal, like that of the side rails 160 and rear roof bow 162. Alternatively, the extensions 164, 166, 168 could be made of a suitable plastic material. Further, the side rails 160, rear roof bow 162, and extensions 164, 166, 168 can be joined together using any suitable method that provides a substantially air-tight connection, such as welding.

The peripheral tubular member 120 also includes a plurality of outlets 170 located in the side rails 160, rear roof bow 162, and extensions 164, 166, 168. The outlets 170 are fluidly communicative with the air supply duct 122 and fluidly connect the side rails 160, rear roof bow 162, and extensions 164, 166, 168 to the corresponding vents 126 positioned in the headliner 124.

In the illustrated example, the side rail 160 extends rearward, beyond the rear roof bow 162, and down at least a portion of the D-pillar 136. This portion of the side rail 160, referred to as a relay duct 172, includes an inlet 174 which fluidly connects the relay duct 172 to the rear air conditioning unit 114. It should be noted that the relay duct 172 may be positioned on the driver-side of the vehicle 112, instead of, or in addition to, the position of the relay duct 172 shown in the drawing.

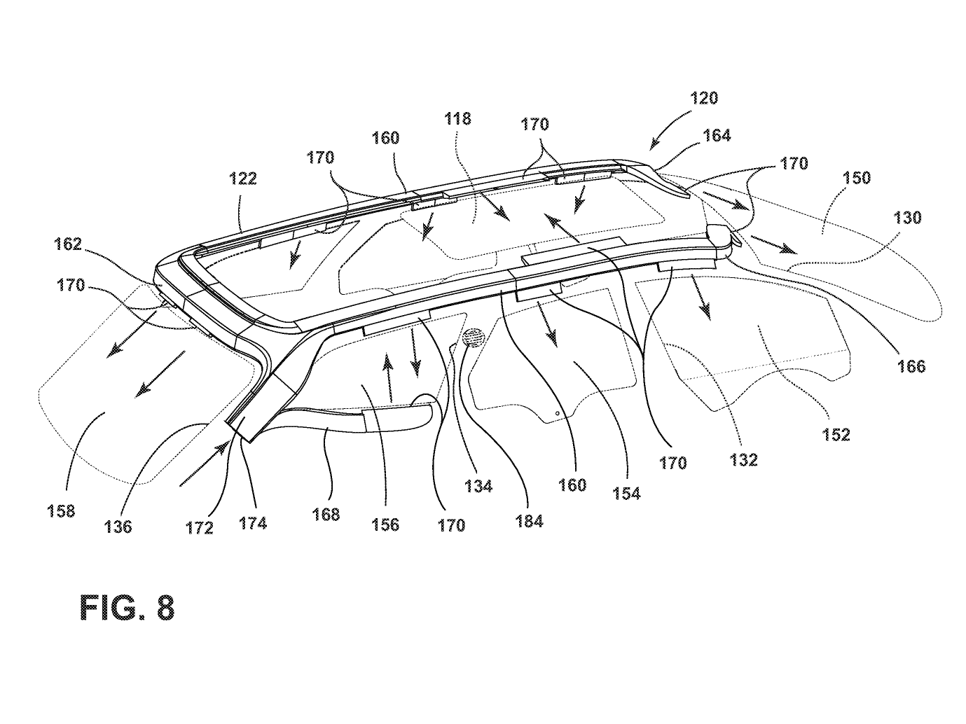

In operation, conditioned air, illustrated in FIG. 8 by arrows, is generated by the rear air conditioning unit 114 and flows into the inlet 174 of the relay duct 172, thereby entering the supply duct 122. From the relay duct 172, conditioned air flows into the side rail 160, rear roof bow 162, and lower rear extension 168. The conditioned air flows through the rear roof bow 162 and into the far side rail 160. The conditioned air flows though the length of both side rails 160, and finally to the two front extensions 164, 166. Because the peripheral tubular member 120 is hollow, and the components thereof are joined together in air-tight fashion, conditioned air provided by the rear air conditioning unit 114 is able to flow from the rear of the vehicle 112 to the front to supply conditioned air to substantially the entire interior 128.

The outlets 170 of the peripheral tubular member 120 are positioned and angled to blow conditioned air onto the adjacent windows. For example, the two outlets 170 in the front extensions 164, 166 blow conditioned air down onto a windshield 150; the outlets 170 on the side rail 160 blow conditioned air down onto a front window 152, a side window 154, and a rear window 156; and the outlets 170 in the rear roof bow 162 blow conditioned air down onto a rear windshield 158. Additionally, the outlet 170 in the lower rear extension 168 blows conditioned air up onto the rear window 156, and two outlets 170 on the side rail 160 blow conditioned air across the moonroof 118. Further, a vent 184 may be positioned in one of the pillars 130-136, and in fluid communication with the air supply duct 122. In the example illustrated in FIG. 6, the vent 184 is shown located in C-pillar 134, and is fluidly connected to the side rail 160 by a connecting duct (not shown). The illustrated example is just one example of possible locations for the vent 184, other locations in the pillars 130, 132, 136 are also feasible.

The climate control system 110 may also include a front air conditioning unit 142 (FIG. 6), which may be fluidly connected to the supply duct 122. The front air conditioning unit 142 can supplement, or replace, the air flow that is supplied by the rear air conditioning unit 114.

The climate control system 110 takes advantage of the hollow peripheral tubular member 120 to run conditioned air into the interior 128 of the vehicle 112, which is beneficial given the current automotive trend of having larger, or multiple, moonroof openings which reduces the package space available for overhead ducting in the roof of the vehicle 112. By utilizing the peripheral tubular member 120, the climate control system 110 eliminates the need for the traditional overhead ducting, which takes up package space between the headliner 124 and the roof panel 116. Additionally, the increased glass in the vehicle 112 from the large moonroof creates an extra thermal load on the vehicle 112 (more glass that requires defogging). The climate control system 110 is a robust and economical solution.

It is to be understood that variations and modifications can be made on the aforementioned structure without departing from the concepts of the present invention, and further it is to be understood that such concepts are intended to be covered by the following claims unless these claims by their language expressly state otherwise.

1. A climate control system for a vehicle comprising:
an air conditioner positioned in a rear of the vehicle;
a roof panel having a moonroof opening bounded on at least one side by a moonroof rail, the moonroof rail generally defining an air supply duct between a headliner and the roof panel, the air supply duct in communication with the air conditioner; and
a plurality of vents that are operably connected to the moonroof rail and that relay conditioned air from the air supply duct to an interior of the vehicle.

2. The climate control system of claim 1, wherein the moonroof rail extends longitudinally on a driver side and a passenger side of the vehicle and laterally at a rear portion of the vehicle.

3. The climate control system of claim 1, further comprising:
a relay duct that extends between the air conditioner and the moonroof rail.

4. The climate control system of claim 3, wherein the air supply duct includes a formed conduit.

5. The climate control system of claim 1, further comprising:
an air conditioner positioned in a front of the vehicle.

6. The climate control system of claim 1, wherein the roof panel has at least two moonroof openings.

7. The climate control system of claim 1, wherein the air supply duct is in communication with at least one of an A-pillar, a B-pillar, a C-pillar, and a D-pillar of the vehicle, and wherein the at least one of the A-pillar, B-pillar, C-pillar, and D-pillar includes a vent open to an interior of the vehicle.

8. A climate control system for a vehicle comprising:
a roof support structure including a peripheral tubular member, the peripheral tubular member generally defining an air supply duct disposed between a headliner and a roof panel, and in communication with an air conditioner; and
a plurality of vents extending from the air supply duct that relay conditioned air to an interior of the vehicle.

9. The climate control system of claim 8, further comprising:
a moonroof disposed in the roof panel, the moonroof being surrounded by the roof support structure.

10. The climate control system of claim 8, wherein the air conditioner includes a front air conditioning device and a rear air conditioning device.

11. The climate control system of claim 8, wherein the roof panel has at least two moonroof openings.

12. The climate control system of claim 8, wherein the air supply duct is in communication with at least one of an A-pillar, a B-pillar, a C-pillar, and a D-pillar of the vehicle, and wherein the at least one of the A-pillar, B-pillar, C-pillar, and a D-pillar includes a vent open to an interior of the vehicle.

13. A climate control system for a vehicle comprising:
a roof panel having a headliner coupled thereto;
a plurality of structural frame members disposed between the headliner and the roof panel;
an air supply duct defined by the structural frame members and in communication with an air conditioner; and
a plurality of vents that relay conditioned air from the air supply duct to an interior of the vehicle.

14. The climate control system of claim 13, wherein the structural frame member is defined by at least one supporting tubular member.

15. The climate control system of claim 13, wherein the structural frame members are moonroof rails.

16. The climate control system of claim 15, wherein the moonroof rails include a driver side moonroof rail, a passenger side moonroof rail, and a rear cross-car moonroof rail.

17. The climate control system of claim 15, further comprising:
a relay duct that extends between the air conditioner and the moonroof rails.

18. The climate control system of claim 13, wherein the air conditioner is positioned in a rear of the vehicle.

19. The climate control system of claim 13, wherein the roof panel has at least two moonroof openings.

20. The climate control system of claim 13, wherein the air supply duct is in communication with at least one of an A-pillar, a B-pillar, a C-pillar, and a D-pillar of the vehicle, and wherein the at least one of the A-pillar, B-pillar, C-pillar, and a D-pillar includes a vent open to an interior of the vehicle.
